(19) United States
(12) Patent Application Publication
(10) Pub. No.: US 2024/0005379 A1
(43) Pub. Date: Jan. 4, 2024

(54) COMPUTER SYSTEMS AND METHODS TO IDENTIFY AND FACILITATE SELECTION OF CANNABIS STRAINS AND PRODUCTS

(71) Applicant: Michael Zsigo, East Lansing, MI (US)

(72) Inventor: Michael Zsigo, East Lansing, MI (US)

(21) Appl. No.: 18/343,207

(22) Filed: Jun. 28, 2023

Related U.S. Application Data
(60) Provisional application No. 63/358,067, filed on Jul. 1, 2022.

(51) Int. Cl. G06Q 30/0601

(52) U.S. Cl. CPC G06Q 30/0631; G06Q 30/0627; G06Q 30/0641

(57) ABSTRACT

A computer data structure for recommending one or more Cannabis products. The data structure may include a database schema. The database schema may include a structured query language (SQL) database including an input-receiving schema and a mapping schema. The input-receiving schema may be configured to receive compositional data about the Cannabis products and user information such as consumer's medical conditions and/or preferences. The mapping schema may be configured to assign a score to each of a plurality of Cannabis products based on the compositional data and user information. The mapping schema may include a ranking schema representing relational data tables and associating portions of the compositional data with one or more conditions. A selection-processing application may use the input-receiving schema and mapping schema to display one or more Cannabis products from the plurality of Cannabis products with the greatest score(s) or score(s) above a threshold amount.

### CROSS-REFERENCE TO RELATED APPLICATIONS

This application claims the benefit of U.S. Patent Provisional Application No. 63/358,067 filed on Jul. 1, 2022, which is hereby incorporated by reference in its entirety.

### TECHNICAL FIELD

This disclosure relates to computer systems and methods for identifying, searching, and selecting Cannabis products.

### BACKGROUND

Cannabis has been used spiritually, medicinally, and/or recreational for many years. Cannabis use generally involves consumption for one or more desired biological effects. Cannabis includes marijuana which is most known for psychoactive effects associated with the cannabinoid tetrahydrocannabinol (THC). Cannabis also includes hundreds of other compounds including many other cannabinoids, flavonoids, and terpenes, each of which may have different desirable and/or undesirable biological effects. For example, the cannabinoid known as cannabidiol (CBD), has become of great interest more recently for its potentially beneficial effects. As demonstrated by changes in many state laws, society is also becoming more accepting of Cannabis and has recognized the many potential benefits of responsible Cannabis use. This has greatly contributed to the availability of various Cannabis products and numerous Cannabis strains which each include different compounds and concentrations thereof. Further, many factors including cultivation and processing may affect the composition of a Cannabis plant. These factors as well as the high number of strains make it difficult to identify, search, and/or select strains for a specific purpose.

### SUMMARY

A data structure for recommending a Cannabis product is disclosed. The data structure is arranged to receive input or data and recommend one or more products. The data structure may include an input receiving schema, a mapping schema, and an application such as a selection-processing application. The input-receiving schema may be configured to receive compositional data of one or more Cannabis products and/or user data such as user preference information or condition information. Preference information may include preferred tastes, smells, cannabinoids and/or terpenes. Condition information may include medical conditions of the intended consumer such as chronic or acute pain. The mapping schema may be configured to assign a score to each of a plurality of Cannabis products. The score may be based on compositional data and/or user data received by the input-receiving schema. The mapping schema may include a ranking schema representing relational data tables that associate portions of the compositional data with one or more conditions. The data structure is embodied on a computer-readable medium. The data structure includes a database schema such as structured query language (SQL) database(s) for acquiring data such as compositional data of products such as Cannabis products. The selection-processing application use the input receiving schema and mapping schema to display one or more Cannabis products from the plurality of Cannabis products that have the greatest score(s) or scores above a threshold amount.

A computer system for identifying and selecting suitable Cannabis goods is disclosed. The computer system includes a non-transitory computer-readable medium with computer-executable instructions thereon. The instructions may include identifying a plurality of products, receiving input associated with a consumer, associating one or more compounds with a biological effect, associating the biological effects as a preventive and/or treatment to one or more biological conditions, and providing a recommendation. The system may receive compositional data corresponding to each product of the plurality of products, identifying a plurality of compounds corresponding to the products based on the compositional data, and assigning one or more biological effects to the product based on the associations. The recommendations may be based on the input received and the biological effects assigned to each product.

A computer method of identifying and/or selecting suitable Cannabis goods for a customer is disclosed. The computer method includes receiving compositional data about the plurality of Cannabis products, identifying a plurality of compounds for each Cannabis product, associating a plurality of compounds with one or more conditions, receiving consumer preference data, associating the plurality of compounds with one or more user preferences, and displaying a recommendation. The recommendation may be provided based on scores from a scoring algorithm. The scoring algorithm may consider the compositional data, consumer preference data, and various associations when providing a score for the plurality of Cannabis products.

### BRIEF DESCRIPTION OF THE DRAWINGS

FIG. 1 is a computer system having a data structure to assist with identifying, searching, and/or selecting Cannabis products.

FIG. 2 is a computing device that may be used with the system of FIG. 1.

FIG. 3 is a first embodiment of a computer graphical user-interface (GUI) of an application.

FIGS. 4 and 5 are embodiments of screens to receive information from a customer/consumer based on a first identification/recommendation/search strategy.

FIG. 6 is an embodiment of a summary confirmation screen.

FIG. 7 is an embodiment of a screen to receive information from a customer/consumer based on a second identification/recommendation/search strategy.

FIG. 8 is an embodiment of a user-interface for an employee.

FIG. 9 is an embodiment of a user-interface for an employee.

FIG. 10 is a flowchart to illustrate a method of recommending a Cannabis product.

FIG. 11 is an embodiment of a summary product profile.

FIG. 12 is another embodiment of a user-interface configured to assist with identifying, searching, and/or selecting Cannabis products.

FIGS. 13-17 are other embodiments of user-interfaces configured to receive information from a customer/consumer.

FIGS. 18 and 19 collectively depict an embodiment of user-interfaces configured to receive a product recommendation based on compositional data and user input.

FIGS. 20-24 collectively depict still another embodiment of user-interfaces configured to receive information from a customer/consumer.

FIGS. 25 and 26 collectively depict another embodiment of summary confirmation user-interfaces.

FIGS. 27 and 28 collectively depict yet another embodiment of user-interfaces configured to receive information from a customer/consumer.

FIGS. 29-31 are embodiments of an administrator screen to create a mapping.

FIGS. 32-34 are another embodiment of a user-interface for an employee.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Processing and memory constraints have necessitated the need for efficient platforms, architectures, and data schemas to allow interoperability with various devices such as mobile devices. The existing computer systems, software, and methods do not provide adequate technical solutions that provide efficient and accurate identification, recommendation, and selection platforms, architectures, and data schemas for products/goods such as Cannabis products/goods. Mobile devices may have limited processing capabilities, memory availability, and data transmission capabilities. Movement from high-performance computational systems to mobile devices has increased the gravity of deficient data structures and communication methods. The embodiments described herein may include online websites or applications that are accessible via mobile devices.

It has been proposed that the sum of all the components (e.g., terpenes, flavonoids, and cannabinoids) of a Cannabis sample contribute to an overall biological effect (i.e., the entourage effect). Accordingly, it may be useful to quantify, compare, and/or summarize the sum of various components of a specific Cannabis product with regards to its intended use (e.g., a particular biological effect or effects) as well as chemically and/or biologically quantify and compare individual compounds within a product or the chemical and/or biological relationship between specific compounds.

In one or more embodiments, this is accomplished with an efficient and flexible system including a data structure such as a structured query language (SQL) database for determining, storing, and/or communicating scores and/or ranks for various Cannabis products as they relate to one or more intended uses. The Cannabis products may be different strains, different batches, and/or incorporated in different forms. In one or more embodiments, the Cannabis products may be scored or ranked among a specific category such as but not limited to flower, cartridges, concentrates, edibles, sugars, tinctures, and/or dough batters. Otherwise, certain categories such as concentrates may also dominate the ranking and/or score. The system and/or database schema may employ various associations and/or an algorithm to determine the score and ranking. The system may employ a recommendation based on the score and/or ranking. For example, a certain number (e.g., 3, 5, 7, 10) of the highest scoring products may be recommended. In a refinement, all the products having a score above a predetermined threshold score may be displayed.

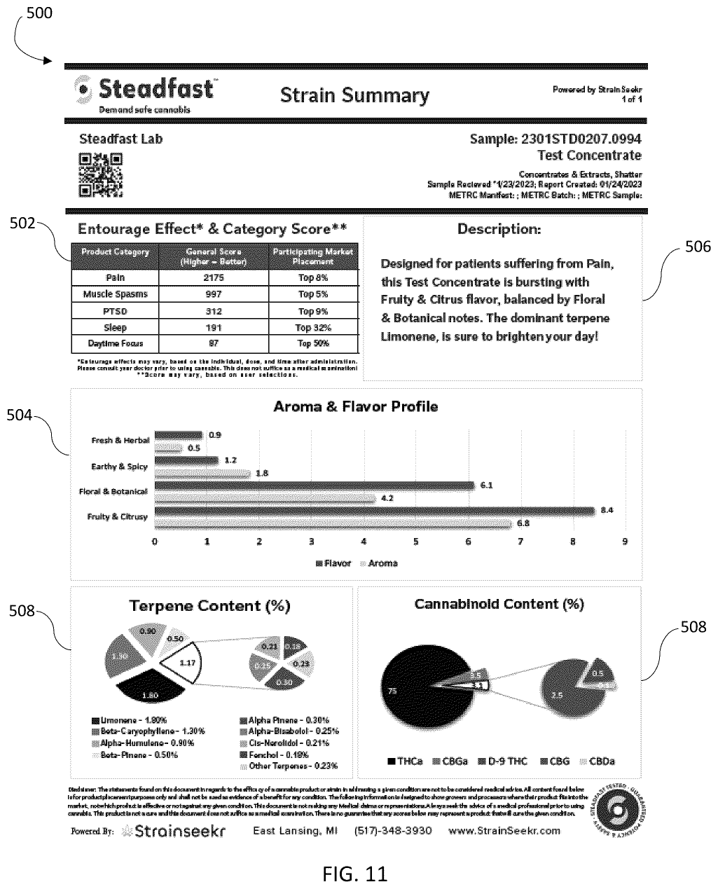

In yet another embodiment, a product profile or summary thereof 500, as shown in FIG. 11, may be provided by the system/schema. The profile may be based on the compositional data and compounds therein. The profile may also be based on a mapping that, for example, maps the compositional data to conditions, biological effects, and/or symptoms. In still another embodiment, the profile may include one or more relationships between compounds in the product and/or relationships 502 with other products and/or conditions. For example, the products may be ranked such that the product profile displays conditions or symptoms that are alleviated by the product 502, i.e., the product is within the top 10% of products for alleviating anxiety. The product profile may also provide a flavor and/or aroma analysis and/or description 504. A product summary or description 506 may also be included in the product profile or summary thereof. The product profile may also include summaries 508 of the compositional data such as the cannabinoid content, terpene content, and/or the flavonoid content. Charts, bar charts, line graphs, pie charts, text descriptions or any other suitable means may be used to describe and summarize various features of the product. For example, a chart 502 depicting the entourage effect, top scores, and/or top effects of a given product, a bar chart illustrating aroma and/or flavor, and pie charts summarizing the terpene content and cannabinoid content as well as a text description may be provided as shown in FIG. 11.

The score and ranking may be based on compositional data as it relates to one or more Cannabis products. For example, a specific Cannabis product may be tested for compositional data which may be uploaded or received by the system. For example, the data structure/schema may include an input-receiving schema. The input-receiving schema may receive compositional data into the data structure/schema such as by transferring the data from a lab, third-party database, scanning reports (e.g., a certificate of analysis), manual entry, an application programming interface (API) or other suitable manner. Alternatively, or in combination the input-receiving schema may receive processing information. For example, whether the Cannabis product processing involved hot pressing, CO₂, butane, or other processing compounds or techniques.

The compositional data may include one or more compounds of the Cannabis product such as cannabinoids, terpenes, and/or flavonoids. The compositional data may also include the quantities, amounts, and/or concentrations of the various compounds. Each product may be associated with the various compounds and quantities/amounts/concentrations thereof. For example, a Cannabis product may be represented, stored, referenced, and/or associated with one or more parameters such as a name/description (e.g., OG Kush), an ID (e.g., StrainID and/or productID), batch, harvest date, test date, availability, manufacturer/supplier, dispensary, location or a combination thereof.

The composition of a Cannabis product may be impacted by numerous factors including but not limited to cultivation techniques, grow season, grow time, environmental conditions, soil/nutrient system, strain, processing, and even testing techniques. Accordingly, even different batches of the same strain may have different compositions and consequentially different biological effects.

Providing an accurate and reliable data structure to recommend products based on a consumer's demands is absent from the growing and evolving Cannabis market. Unlike many markets, agricultural or cultivated products easily vary from season to season. Accordingly, identifying and analyzing these products in real-time by their composition and customer input may be advantageous to maintaining customer satisfaction.

Conventionally, dispensaries provide burdensome, lengthy, and/or confusing menus which rarely result in consumer satisfaction and identifying the best product for consumers' needs. In situations where recommendations are provided, they are conventionally provided by budtenders or other employees based on the ad hoc information conveyed from customer. The recommendations are further based on subjective employee/customer experiences. The budtenders/employees often rely on their personal and professional experience, or unreliable feedback from customers. However, this type of information is generally less reliable and rarely satisfactory given the subjective nature of consumer preferences and the diverse scope biological responses. The dynamic and revolving inventory of Cannabis product only adds complexity. Even if a consumer does receive an accurate and reliable recommendation, it's even more difficult to do consistently.

Providing a computer system and/or data structure that provides accurate and consistent recommendations based on a consumer's demands, and/or current inventories will reduce the number of time customers spend in the store and the time to sale. It also reduces the amount of time spent with employees, improves customer satisfaction, and increases the number of transactions. Dispensaries have employed various software applications for making their work more efficient and/or accurate but this software does not consistently provide reliable recommendations.

For example, software to recommend Cannabis products based on consumer feedback has been used. But ignoring actual compositional data and not considering the dynamic nature of Cannabis products from season to season creates issues. This is evident by software that generally recommends Cannabis products but isn't linked with a specific dispensary or location. It's rare that different dispensaries throughout a state or throughout the country will have the same composition and thus the same biological effect even if being from the same strain of Cannabis. Current analysis software that considers compositional data may provide complex reporting that is confusing, undecipherable, and/or burdensome to employees and customers. Still further, it would be impossible for an individual to provide a recommendation in real time based on a mapping of compositional data and customer input (e.g., preferences) in real-time of an entire inventory of products given the size of data being considered. Further, conventional software does not allow a user to search present inventory products of a dispensary based on specific medical conditions.

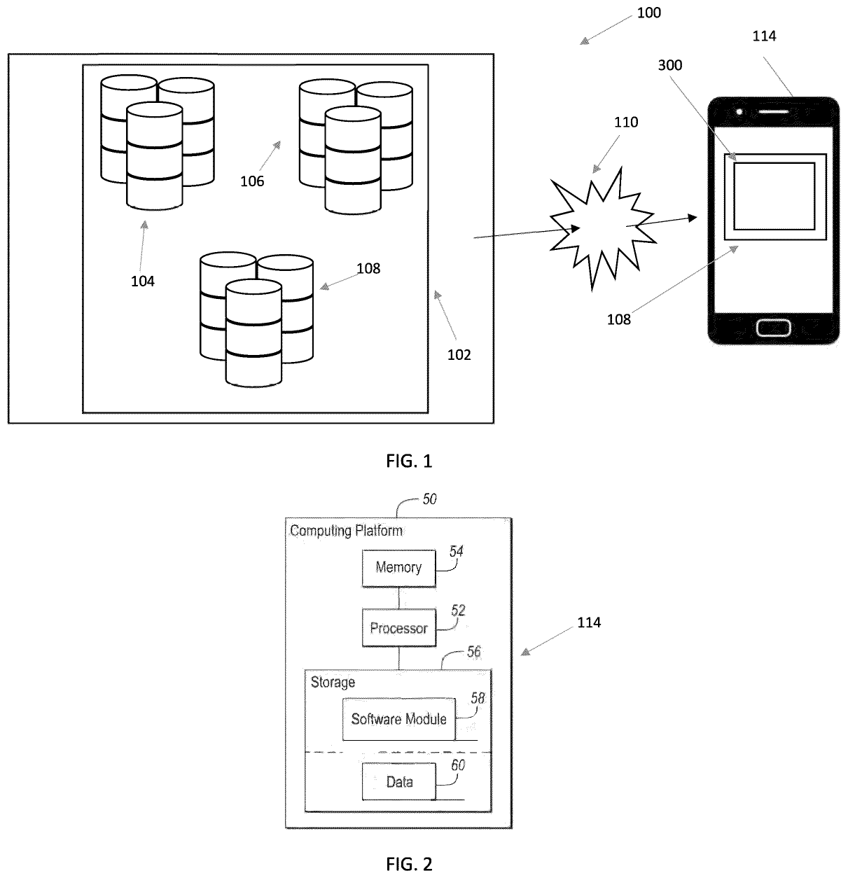

Referring to FIG. 1, a data structure 100 for identifying, searching, recommending, and/or selecting products such as Cannabis products is disclosed. Hereinafter this disclosure may refer to a Cannabis product or Cannabis product(s) but this disclosure embodies other products as well.

The data structure 100 is embodied on a non-transitory computer-readable medium 102 having a database schema for acquiring input in a SQL database, and identifying, recommending, and/or searching one or more representations of each product based on the input. Hereinafter this disclosure may refer to the products directly as opposed to representations of the products, however a person of ordinary skill in the art would understand that in the context of a digital environment (e.g., computer readable medium) it is referring to a representation of, e.g., a Cannabis product and not the actual Cannabis product.

The identification, search function, and/or recommendation may be based on associations and/or the inputs that may be stored in the SQL database. The SQL database may include an input-receiving schema 104 for receiving the input and a mapping schema 106 for developing and identifying the associations. The input-receiving schema 104 and the mapping schema 106 may be used by an application schema 108 that employs an application such as a software application for a website, computer, mobile device, or other computational device 114 (as shown in FIG. 2) that provides a user a graphical user-interface 112 to interact with the system. The computational device 114 may include computing platform 50 including memory 54, processor 52, and storage 56. The storage 56 may include a software module 58 for storing data 60. The user-interface 112 may be available over a network 110 such as the internet (e.g., web-based) or be available on a local network or device such as at a dispensary. For example, a Cannabis-search-and-selection-application, may be used to receive input, search, identify, and/or recommend one or more products (e.g., a plurality of products). The recommendation may display one or more recommended products from a plurality of products.

A computer system for receiving input and providing recommendations of one or more Cannabis products is disclosed. The computer system may include the data structure 100 providing a user-interface 112 to an administrator, employee, customer, and/or consumer via the input-receiving schema 104. In a refinement, the user-interface 112 may be different for administrators/employees and customers/consumers. In a refinement, the user-interface 112 is available over the internet. For example, the user-interface 112 may be available at a web address, alternatively or in combination, an application employing the user-interface 112 may be downloaded to a computational device such as a mobile device. The user-interface 112 may receive information that may be used and/or stored by the data structure 100.

For example, a user-interface 112 for an employee may allow the employee to scan-in or manually enter the results from a document such as laboratory report (e.g., a certificate of analysis) of a new batch or new Cannabis product. For example, the user (e.g., an employee) may select the new batch or new Cannabis product and then scan-in the certificate of analysis (COA). The input-receiving-schema 104 may employ optical character recognition (OCR) to recognize compounds, quantities, and/or concentrations on a COA and/or the input-receiving-schema 104 may recognize a standard reporting format of the testing, or use any other suitable mechanism such as artificial intelligence (AI) for recognizing the data. The new batch or Cannabis product may then be associated with those compounds, quantities, and or concentrations. Although, described herein with reference to a certificate of analysis, other documents or mechanism of obtaining and inputting the information may be used. For example, as an alternative or in combination, the information may be manually uploaded or uploaded from a third-party source such as a testing lab's database or system. In yet another example, an application programming interface (API) may be used to facilitate data sharing between testing facilities and distributors (e.g., dispensaries) such as by uploading the results to a centralized medium. In some embodiments, the API may also provide the testing facility access to the product information such as the product profile or a summary thereof.

For example, the compositional data may include but is not limited to compounds such as cannabinoids, flavonoids, and/or terpenes. Cannabinoids may, for example, include cannabichromene (CBC), CBD, cannabidivarin (CBDV), cannabigerol (CBG), cannabicyclol (CBL), cannabinol (CBN), THC, and/or tetrahydrocannabivarin (THCV). Flavonoids may, for example, include apigenin, cannflavine A, cannflavine B, cannflavine C, isovitexin, kaempferol, luteolin, orientin, quercetin, and/or vitexin. Terpenes may, for example, include A-terpineol, alpha bisbolol, alpha cedrene, alpha pinene, alpha-humulene, alpha phellandrene, alpha terpinene, B/Y Terpineol, beta caryophyllene, beta pinene, beta mycrene, borneol, camphene, camphor, caryophyllene oxide, CBN, cedrol, cis-caryophyllene, cis-nerolidol, delta 3 came, endo-fenchyl alcohol, eucalyptol, famesene, frenchone, gamma-terpinene, geraniol, geranyl acetate, guaiol, hexahydrothymol (methanol), humulene, isoborneol, isopulegol, limonene, linalool, mycrene, nerol, nerolidol, ocimene, ocimene isomer 1, ocimene isomer 2, pulegone, sabinene, sabinene hydrate, terpineol, terpinolene, trans-caryophyllene, trans-nerolidol, terpineol, valencence, and y-terpinene.

The schemas may cooperate such that the customer/consumer may input information such as identification/personal information (e.g., name, initials, nickname, and/or phone number), a search/recommendation strategy (e.g., condition based and/or compound based), conditions, other consumer information (e.g., pre-existing disorders, symptoms, hereditary disorders, and/or dietary restrictions), consumer preferences, desired biological effects, desired and/or undesired compounds (e.g., cannabinoids and/or terpenes) and/or preferred dispensary/location to identify and search (in-stock) products or receive a recommendation. For example, the customer/consumer may input a symptom/condition (e.g., nausea) indicative of desired biological effects (e.g., anti-nausea) or by specific compositional data such as by digital prompts 309, 311 such as a digital button corresponding to each.

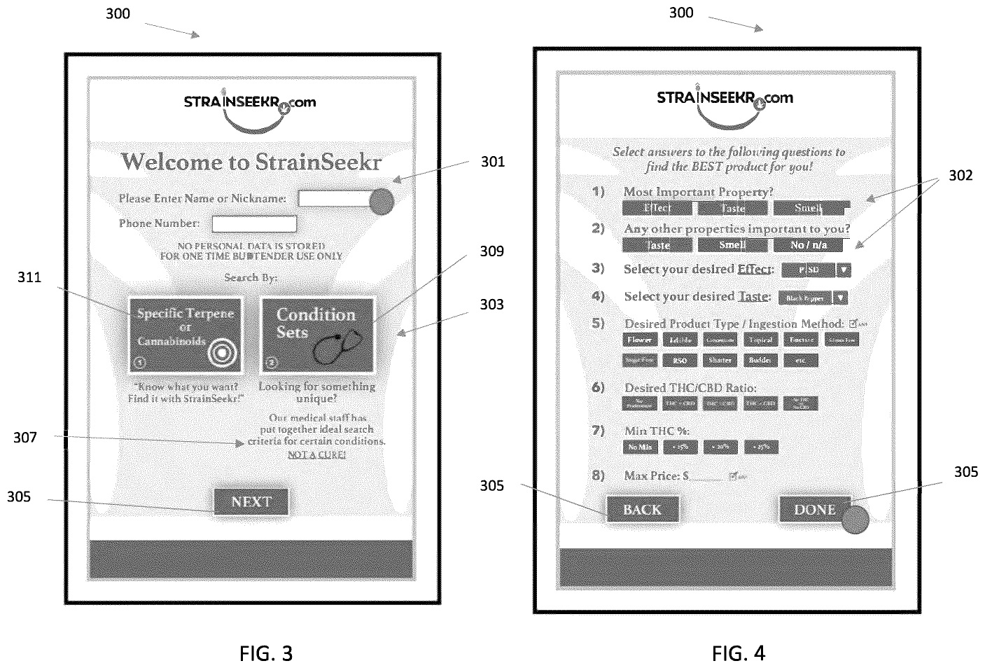

In a variation, this information may be inputted or requested via one or more screens displayed to the customer/consumer, as shown in FIGS. 3 to 9. If multiple screens are used, prompts 305 such as digital buttons may be used to navigate the various screens (e.g., NEXT, SUBMIT, DONE, BACK, and/or EXIT). For example, a user-interface 300 with various screens may be used.

The user-interface 300 for a customer/consumer may also communicate with the input-receiving schema 104 to receive input directly from the customer/consumer. The application schema and/or input-receiving schema may be engaged as described above. For example, a customer/consumer may access the application or input-receiving schema by scanning a QR code which may initiate the downloading of an application (e.g., mobile application) or direct a device to a specific server address (e.g., website) employing such application. In another example, a customer/consumer may access the application schema via a website, website overlay (e.g., pop-up), a point-of-sale system, or even using a programmed kiosk such as one available at the store.

In a refinement, the input-receiving schema 104 may provide a fillable entry box 301 for receiving information and/or one or more selectable option 303. For example, the user-interface 300 may offer a plurality of options such as methods for identifying, searching, and/or receiving a recommendation. For example, a customer/consumer may have a first option to search for Cannabis products by compounds and/or the concentration thereof and have a second option to search by conditions that the Cannabis product may remedy or alleviate. FIG. 3 depicts a screen having a first identification/search/recommendation strategy 309 (e.g., by one or more specific conditions) and a second identification/search/recommendation strategy 311 (e.g., by one or more specific compounds). One or more of these screen may also display advisory or contractual information 307 to a user such as a disclaimer and/or for legal compliance. The input could be requested or received in numerous sequences and is not particularly limited to the specific examples herein.

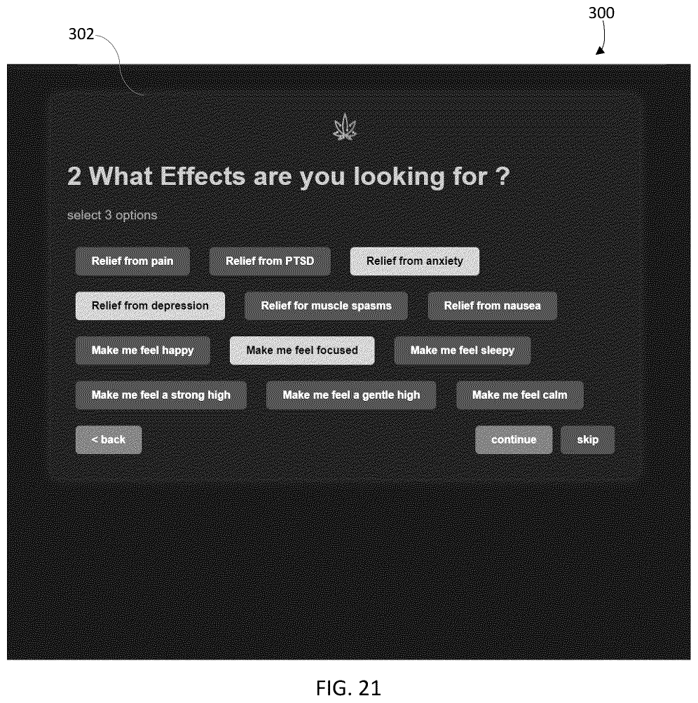

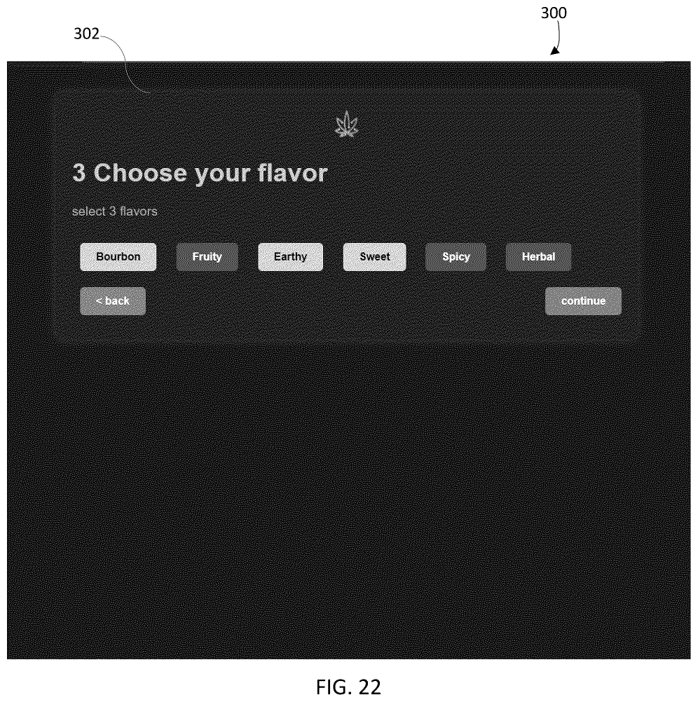

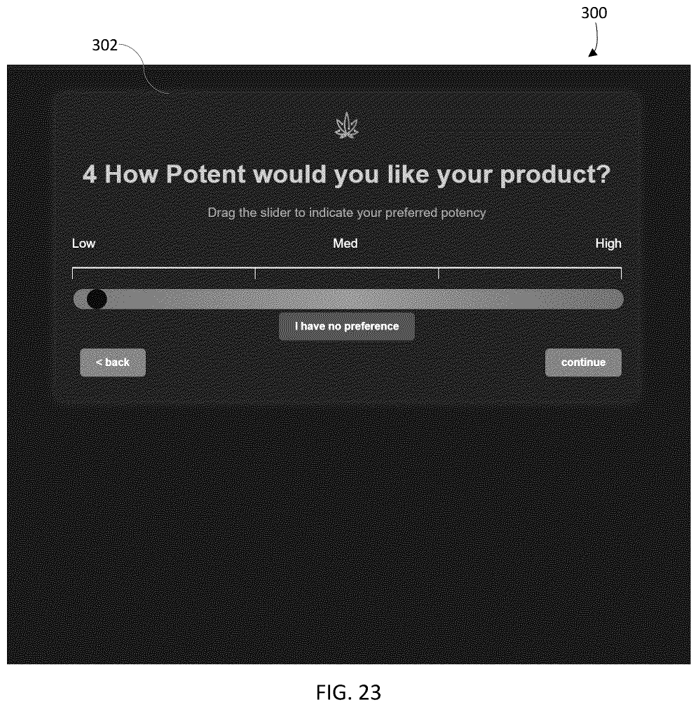

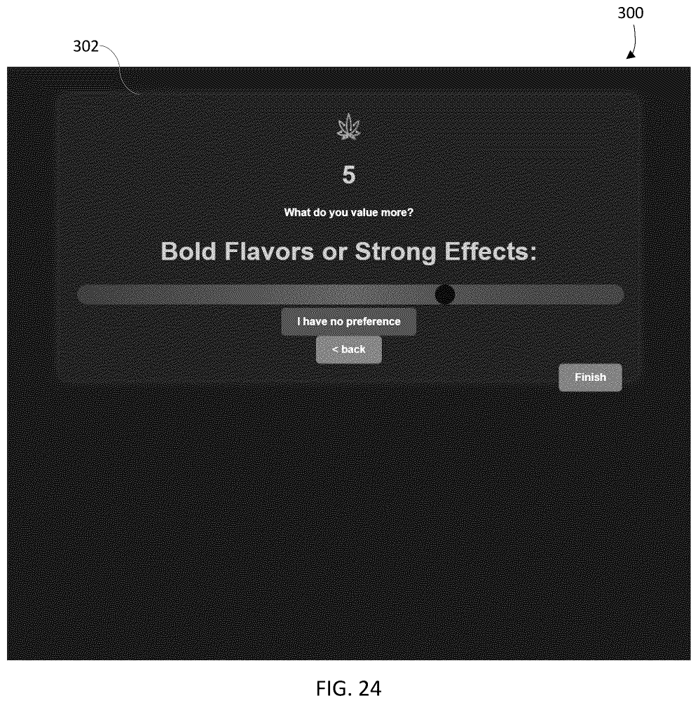

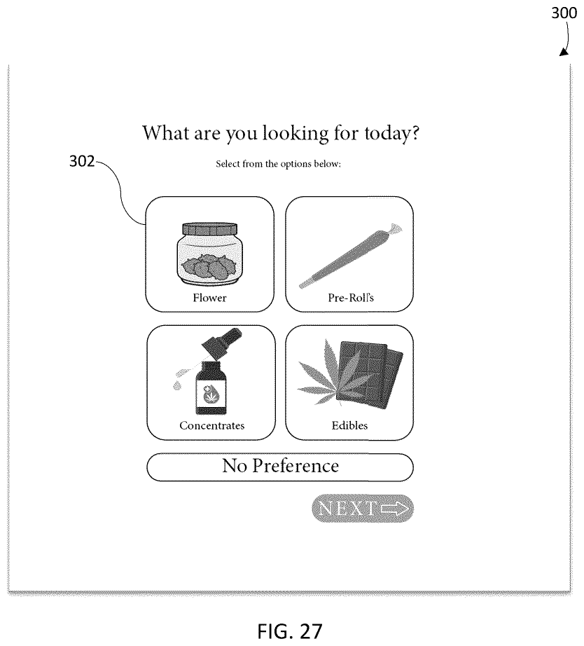

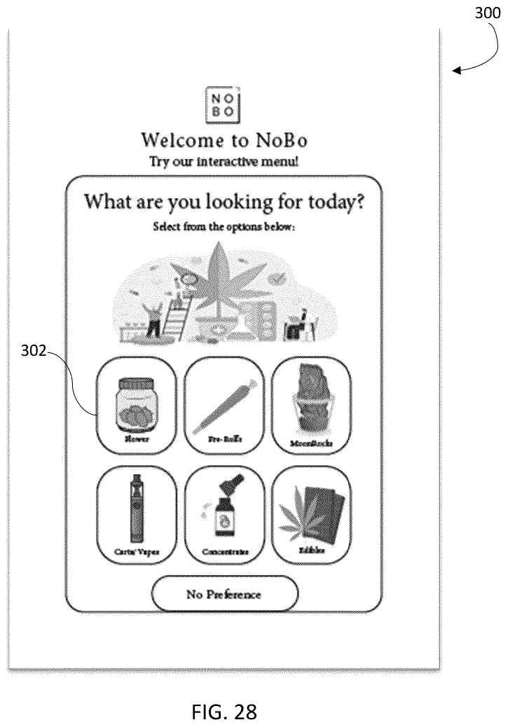

The application and input-receiving schemas may cooperate to receive input information related to the selected identification/recommendation/selection and may receive specific input from the customer/consumer based on the desired identification/recommendation/search strategy selected, as shown in FIGS. 4-5, 13-17, 20-24, 27, and 28.

For example, a customer/consumer may select an identification/recommendation strategy based on one or more conditions of the consumer (e.g., “condition sets”) prior to requesting and inputting such condition information, as shown in FIGS. 4, 15, and 21. The application and input-receiving schemas may cooperate to receive information on whether the customer/consumer has conditions such as pain, cancer, inflammation, arthritis, anxiety, depression, insomnia, other sleep disorders, osteoporosis, human immunodeficiency virus (HIV)/acquired immunodeficiency syndrome (AIDS), seizures, amyotropic lateral sclerosis (ALS), posttraumatic stress disorder (PTSD), Crohn's, glaucoma, fibromyalgia, migraines, Alzheimer's, heart disorders, autism, and/or a terminal illness.

The input-receiving schema 104 may also receive a users' preferences such as but not limited to input indicative of desired and/or undesired tastes and/or smells. The input-receiving schema 104 may also receive other input such as desired or undesired biological effects, personal information such as name, address, phone number, and/or payment information such as for completing a transaction and/or linking a specific recommendation to a customer/consumer. In a refinement, personal information may not be stored and/or may not be accessible to employees. For example, a customer's/consumer's input data, recommendation, and/or profile may be associated with a random code stored in the system and provided to the customer/consumer. In yet another embodiment, the input received by the input-receiving schema from the customer/client may be pre-existing and/or hereditary consumer health disorders, dietary restrictions, and other drugs used. For example, the scoring algorithm may consider, be modified or altered to consider whether a consumer has a pre-existing and/or hereditary consumer health disorder and recommend and/or exclude any products associated with being beneficial and/or detrimental to pre-existing and/or hereditary consumer health disorders such as heart disease, depression, anxiety, diabetes, high blood pressure, etc. Similarly, the scoring algorithm may consider whether a consumer has dietary restrictions such as allergies and/or intolerance. The recommendation may exclude or recommend products based on the dietary restrictions. In yet another variations, the scoring algorithm may considered drug interactions based on the inputted drug(s) to exclude products that may have compounds that may interact with drugs that the consumer has or is using. In a refinement, the drugs include medications such as prescribed medications.

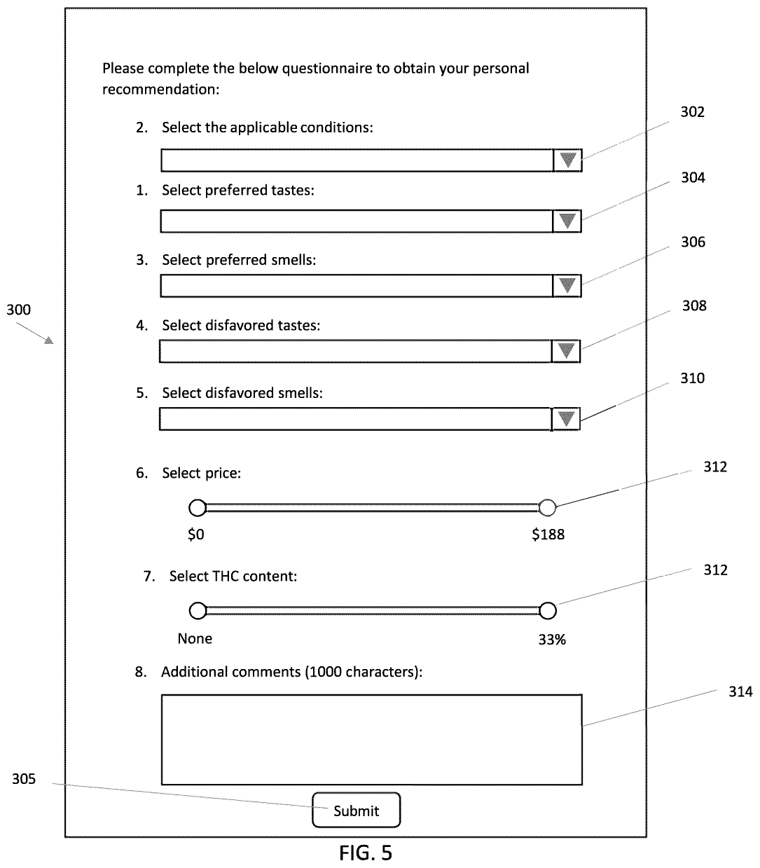

In a variation, as shown in FIGS. 4-5, 13-17, 20-24, 27, and 28, the customer/consumer may be presented with series of questions (e.g., survey). For example, a simple survey (e.g., 1-3 questions), regular survey (e.g., 5-7 questions), or even a comprehensive survey (e.g., 8 or more questions such as 20 questions). In a variation, the user-interface 300 may ask a user for critical product attributes such as terpene content, cannabinoid content, taste, and/or smell, as shown in FIGS. 4 and 5. In a refinement, the user-interface 300 may include prompts 302 (e.g., buttons, drop-down menus, and free form fillable entry blocks). For example, FIG. 4 depicts an embodiment including first and second questions with digital button prompts to acquire priority information, third and fourth questions with drop-down menu prompts to acquire condition and preferred taste information, the fifth through seventh questions with digital button prompts to acquire preferred product type, specific compound ratios (e.g., THC/CBD ratio), and minimum compound concentrations (e.g., THC), and the eighth question with a free-form fillable entry to acquire pricing information.

FIG. 5 presents an alternative user-interface 300 with a first drop-down menu 302 for selecting one or more conditions, a second drop-down menu 304 for one or more desired taste, a third drop down menu 306 for one or more desired smells, a fourth drop down menu 308 for one or more undesired taste, and a fifth drop down menu 310 for one or more undesired smells. The user-interface 300 may also include one or more minimum and/or maximum selection feature(s) 312 for price and a minimum and maximum selection feature for specific compounds such as THC. The customer/consumer may also input additional information in a free form entry section 314. Various designs for soliciting user input may be used.

For example, as shown in FIGS. 4 and 5, a user may first select which attribute is most important such as treating a condition, smell, or taste. After prioritizing attributes, the user may select a value for each such as treating PTSD, and a black pepper taste. For example, attributes may be prioritized by a simple ranking or by adding a weighted value (e.g., severity). For instance, the user may input that alleviating pain at a severity level of 7 and daytime anxiety at a severity level of 4 is preferred giving a greater weight/priority to alleviating pain. In the exemplary embodiment, the user-interface 300 also request other relevant information such as product type or ingestion method (e.g., flower, edible, concentrate, topical, gluten free, etc.), desired THC ratio (e.g., no preference, THC=CBD, THC>CBD, THC<CBD, no THC or CBD), desired THC percent (e.g., set minimum and maximum), and max price. In one or more embodiments, the product type or ingestion method may provide different biological effects or a different degree of effectiveness. In one or more embodiments, the scoring algorithm may consider associations specific to a type of product. For example, a concentrate having a compound may be recommended as opposed to a topical having the same compound because they may have different biological effects. Similarly, a concentrate may be recommended as opposed to an edible of the same strain because they provide different biological effects.

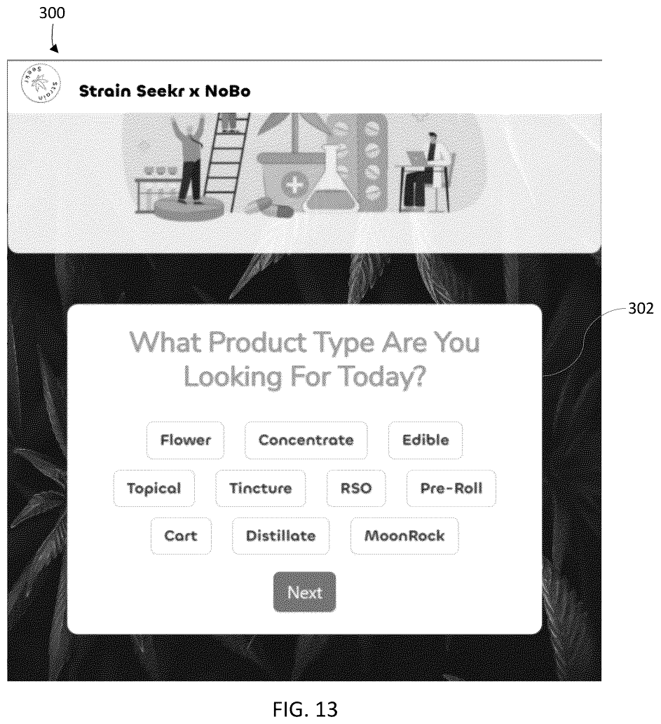

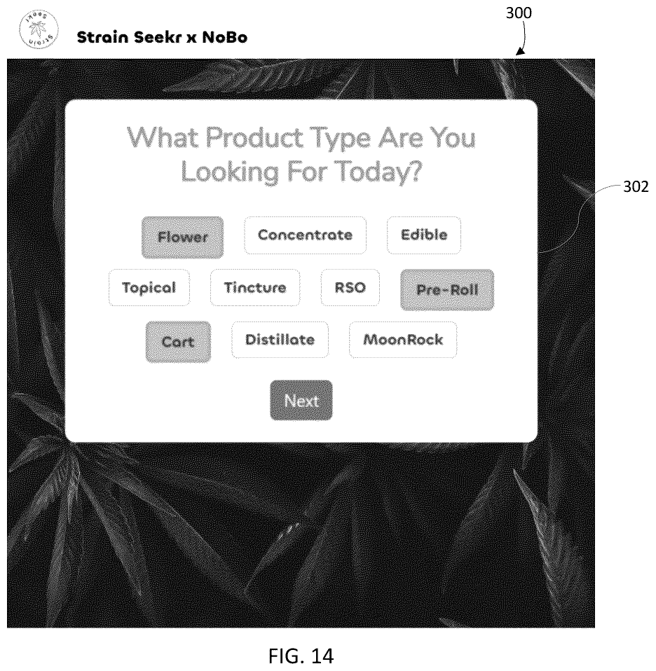

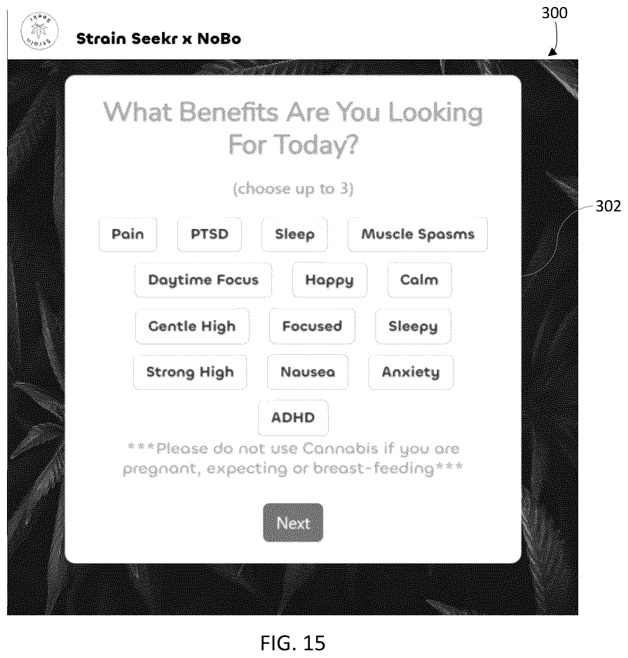

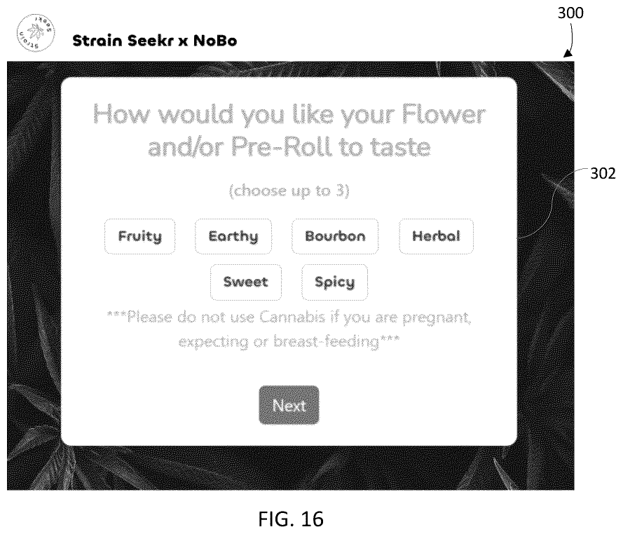

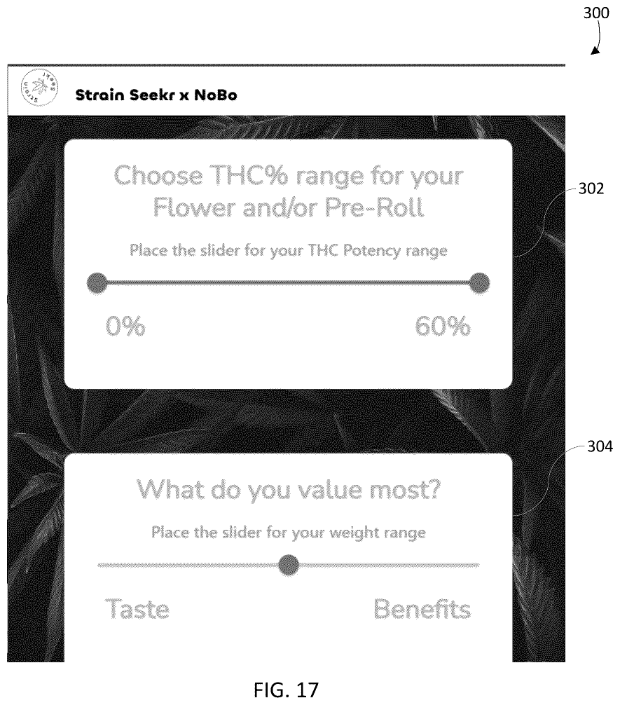

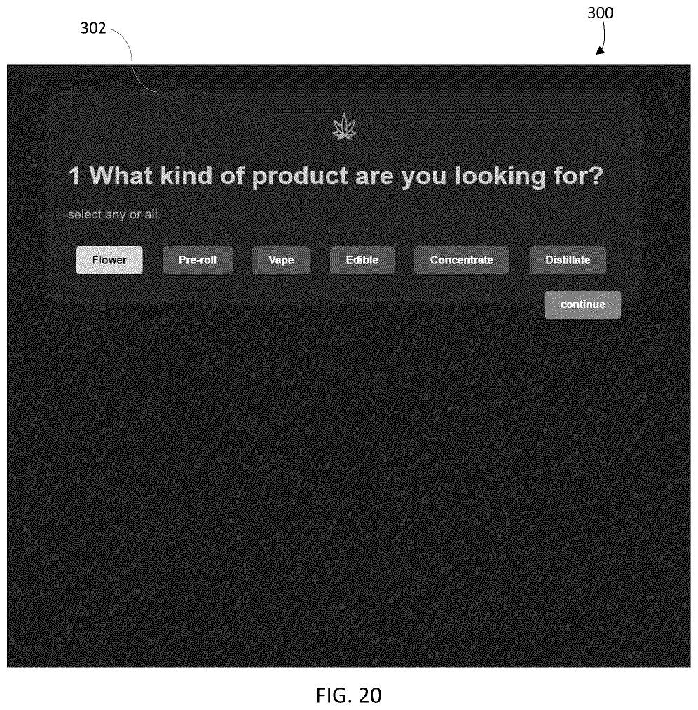

Similarly, the embodiment of FIGS. 13-17, depicts a series of user-interfaces configured to request and to receive input from the user. For example, the user-interfaces may include selectable (e.g., clickable) buttons for one or more inputs, as shown in FIG. 13. Once the user has selected the appropriate prompts 302 in the first request (FIGS. 13 and 14), the user may click another prompt to continue the survey or input process of the input-receiving schema such as by clicking a “Continue” or “Next” button. The first request, for example, may inquire into a desired type of product, conditions/symptoms to be alleviated, a desired biological effect, a taste and/or smell, preferred or excluded compound, one or more compound concentrations, and prioritization inquiry. Upon clicking the continue prompt, the user may be presented with an additional requests such as a second input request (FIG. 15) that is different than the first input request such as a desired type of product, conditions/symptoms to be alleviated, a desired biological effect, a taste and/or smell, preferred or excluded compound, one or more compound concentrations, and prioritization inquiry. The user may again proceed to various additional input request such as in FIGS. 16 and 17. The request for input may use any suitable prompt to request and receive user input. Further, various prompts may be used to further engage and/or more accurately receive user input. For example, FIG. 17 uses digital slider to receive input whereas FIGS. 14-16 use selectable digital buttons. Similarly, in FIGS. 20-24, 27, and 28 alternative graphical user-interfaces may be used to receive information in similar manners. Certain receiving device may be more suitable for certain types of interfaces or input receiving processes. For example, if the input-receiving schema is requesting and receiving input from a mobile device with a relatively small screen providing single request one at a time may be more suitable. Whereas a complete fillable form may be more suitable, for example, when a user is inputting information or preferences from a larger device. In yet another example, a kiosk may use either form however, presenting single request one at a time may simplify the process and improve customer satisfaction.

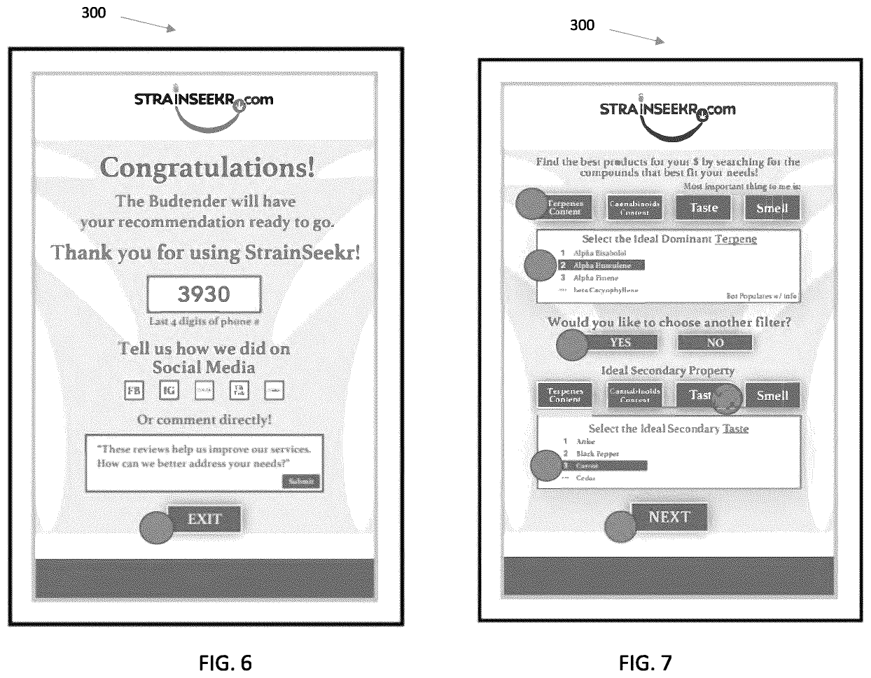

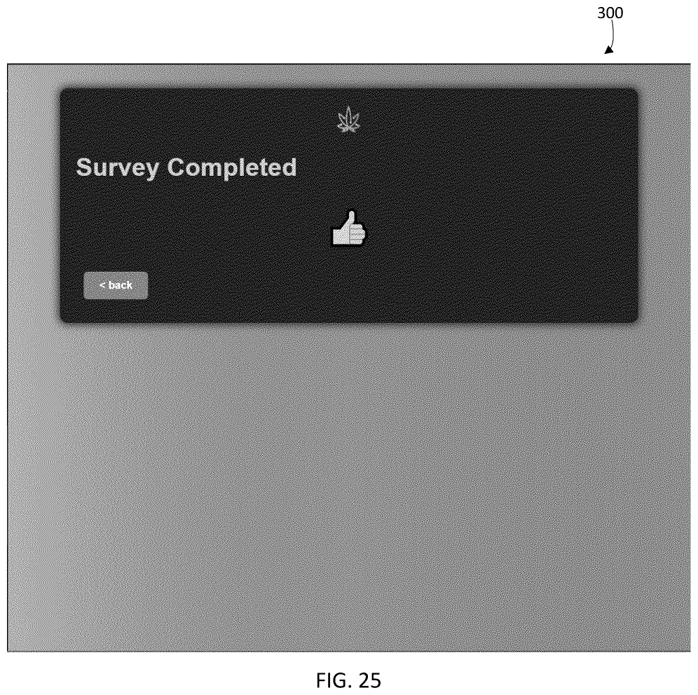

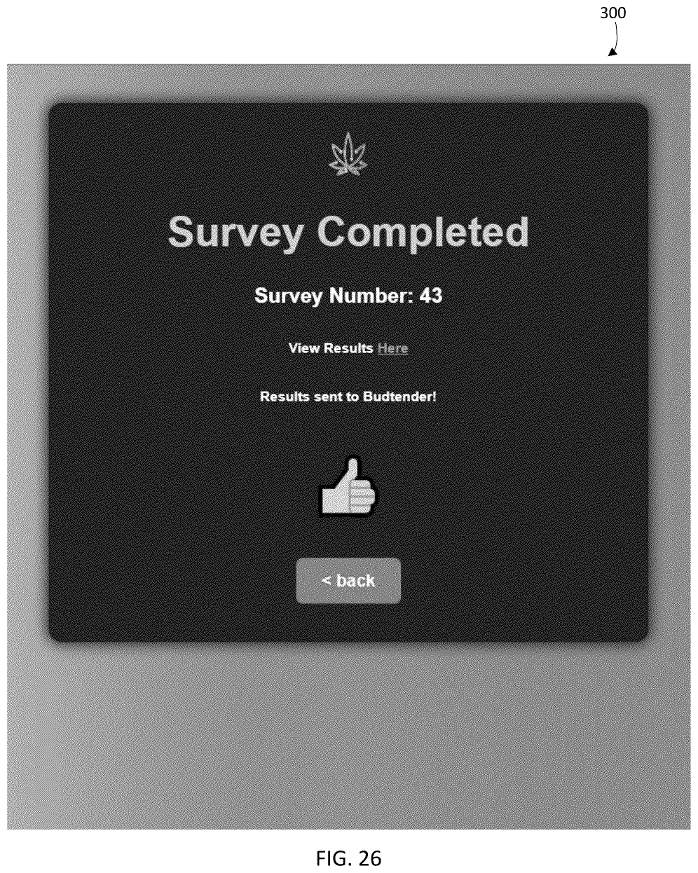

In one or more embodiments, the personal information may be used to identify the recommendation. In a refinement, the recommendation may be identified in a more discrete manner and/or with anonymity such as by, for example, using the last four digits of the customer's phone number, as shown in FIG. 6. Alternatively, sequential (survey) number or random code may be used as discussed above and shown in FIG. 26. After receiving the needed user inputs, again referring to FIG. 6 or FIGS. 25 and 26, the system may provide a summary confirmation screen with information related to the recommendation, feedback, and/or transaction information. For example, an employee of the dispensary may be able to view the recommendation when the customer arrives at the dispensary and provides the necessary identification information (e.g., name, last four digits of phone number, or a random code).

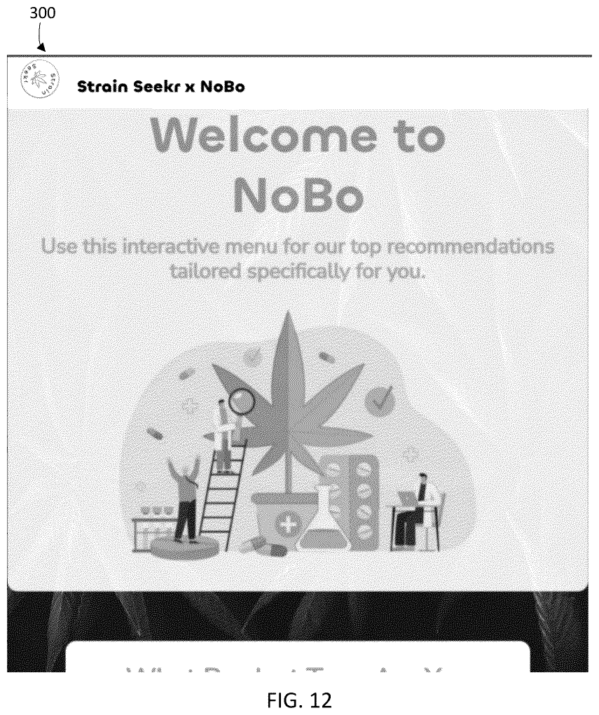

As shown in FIGS. 3, 12, 27, and 28 the customer/consumer may also access the input-receiving schema via the user interface 300 by selecting to search and/or identify products by compositional data. For example, the customer/consumer may search for a specific compound (e.g., specific cannabinoid and/or terpene) and/or exclude a specific compound. In a refinement, the customer/consumer may also specify permissible and/or impermissible amounts or concentrations. Alternatively, the user may be able to prioritize compounds (e.g., terpenes and/or cannabinoids) relative to one another. For example, a user may be able to select a dominant and/or inferior compound. Alternatively, the user may be able to rank favorable or unfavorable compounds. For example, as shown in FIG. 7, after selecting “Specific Terpenes or Cannabinoids,” a user may be able to select terpene content and/or cannabinoid content of the product. In a refinement, the user may also be able to identify other important attributes such as taste, smell, or treatment of specific conditions. For example, FIG. 7 illustrates the selection of the terpene Alpha Humulene as the dominant terpene and a carrot taste as an additional attribute or characteristic of the product.

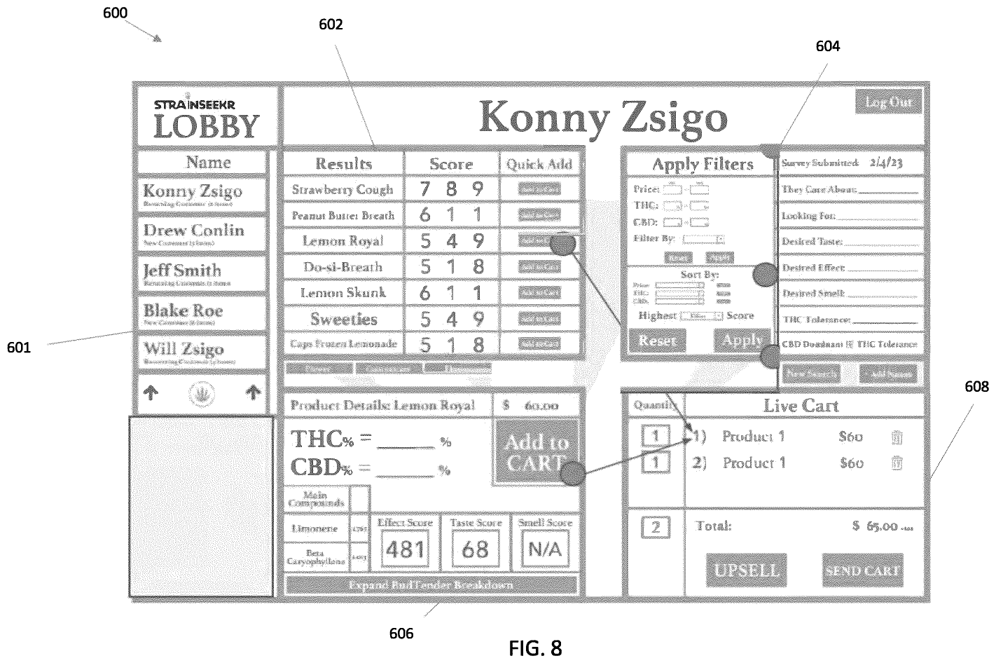

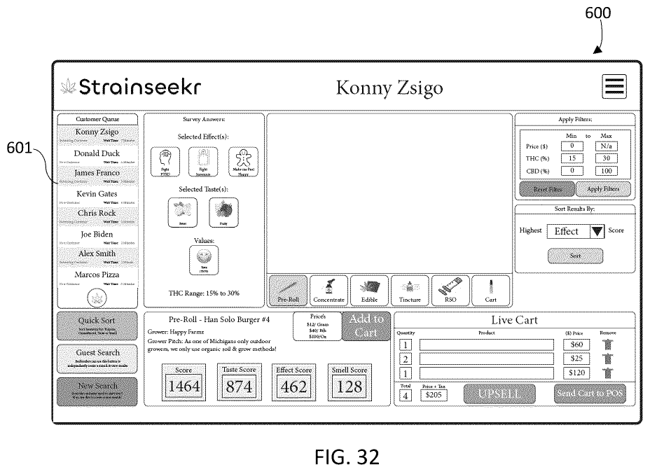

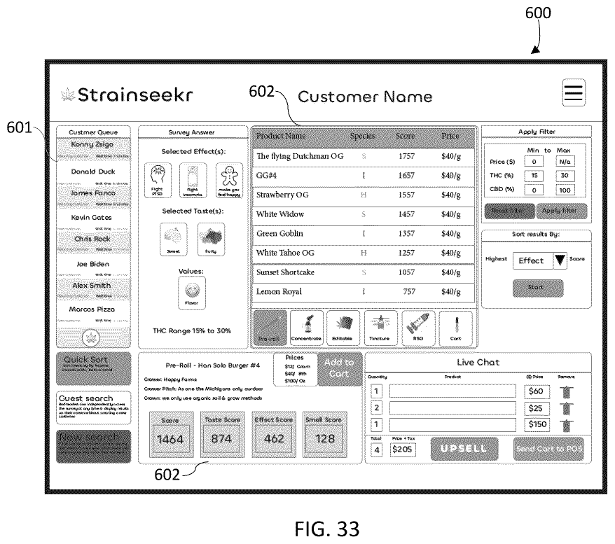

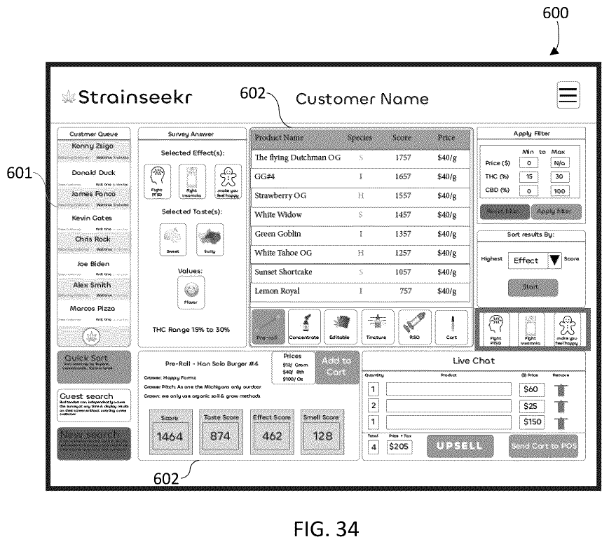

After inputting user preference information into the input-receiving schema, the system may determine, identify, and/or generate a recommendation for the customer/consumer. The recommendation may be presented to the user and/or an employee of a dispensary. For example, the application schema may include an employee user-interface 600 (i.e., Strainseekr Lobby screen), as shown in FIGS. 8 and 32-34. The employee interface 600 may provide a list of clients/customers/consumers 601 or other information for identifying a plurality of recommendations. The employee may be able to select a recommendation to view one or more recommended products 602 (e.g., a plurality of products). The employee may be able to view, alter, modify, or supplement the user's inputs 604. The employee may also be able to obtain additional information 606 about the recommended products such as by selecting or clicking the products. The additional information may provide amounts or concentrations of specific compounds, dominant compounds, compounds contributing the most to the score, score contributions, scores for specific attributes such as a first score for a biological effect, a second score for a specific taste, and a score for a specific smell. The specific biological effect, taste, and/or smell may be based on the user inputs. The recommendation may also provide an overall score and the score may be the basis for ranking products to provide the recommendation. The additional product information may also provide the basis for the overall score. Various prompts to add the recommended products to a user cart to complete a transaction may also be available. A portion may also provide transaction information 608 such as products involved in the transaction, and pricing/cost information. Although described herein as an employee user-interface, the application schema may also be configured to provide a customer/consumer with the same information such as in a summary screen.

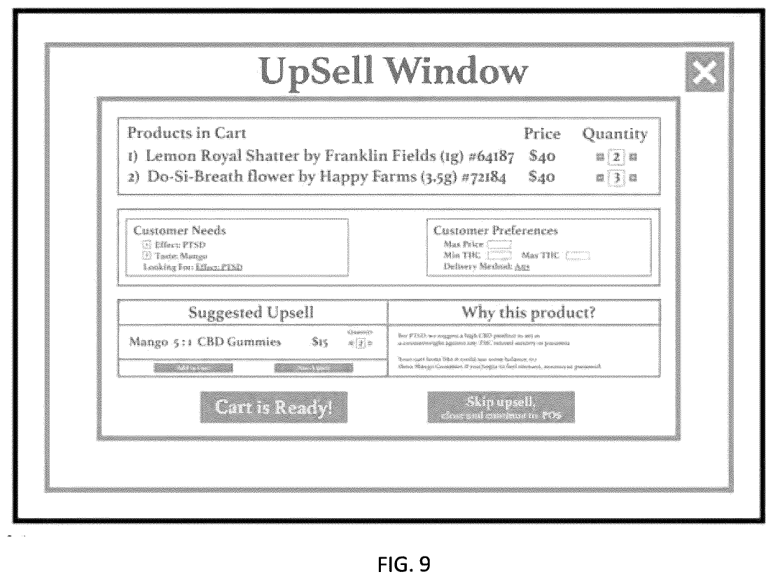

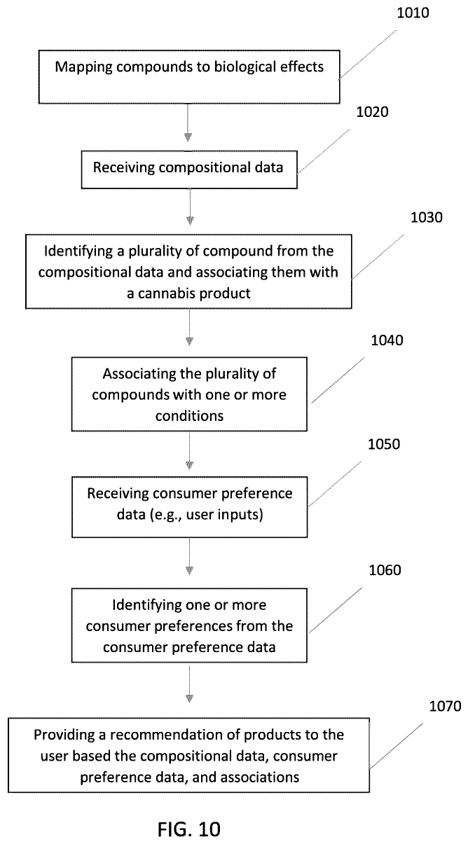

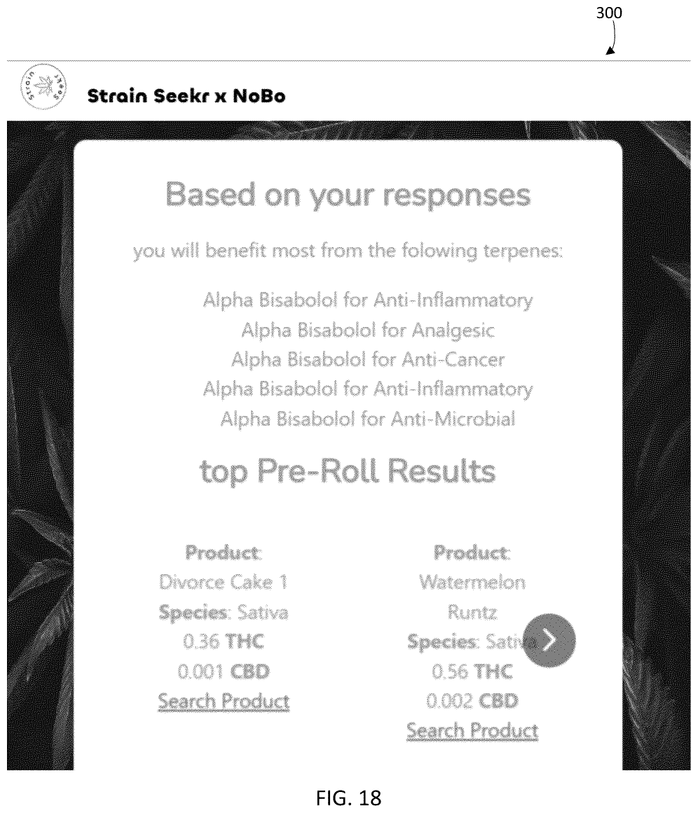

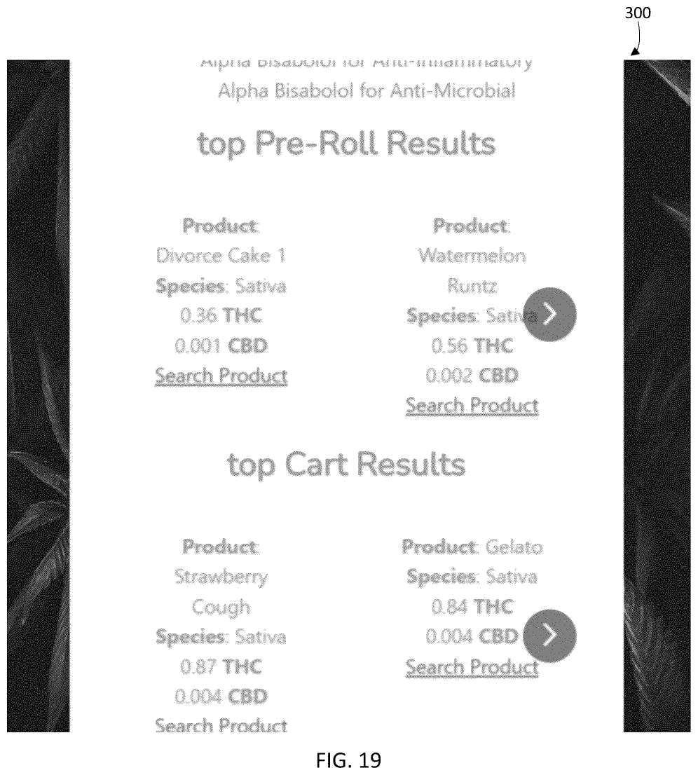

In yet another embodiment, the application schema may assist an employee with additional sales or upselling. For example, a summary and/or upsell screen, as shown in FIG. 9 and/or FIGS. 18 and 19, detailing the customer/consumer's inputs, preferences, purchases, selected products, additional recommended products, and/or additional information about the various products may be provided.

In a refinement, the customer inputs may no longer be accessible to the employee after the purchase is completed. In a variation, the customer/consumer may be able to provide access to previous inputs even after completion of the purchase such as by providing a code or other identifying information. For example, the customer/consumer may want to provide the employee(s) access to previous purchases when making future purchases. After the purchase, the system and/or data structure may also send the customer/client additional information and/or notifications with the provided input. For example, the system and/or data structure may provide the customer with a satisfaction survey or ask for a review of the product. The system may also send promotional materials such as sales, discounts, and/or rewards.

The input-receiving schema 104 may also receive information about each dispensaries' inventory. In a refinement, the input-receiving schema may be in communication with an inventory schema such that the data structure 100 only identifies, searches, and/or recommends Cannabis products that are in inventory. Alternatively, an employee may input whether a Cannabis product is available or unavailable in the input-receiving schema. In a refinement, only available products may be recommended, or the inventory level may contribute or effect the overall score. Alternatively, there may be some indication of whether a product is available or in inventory of a specific dispensary.

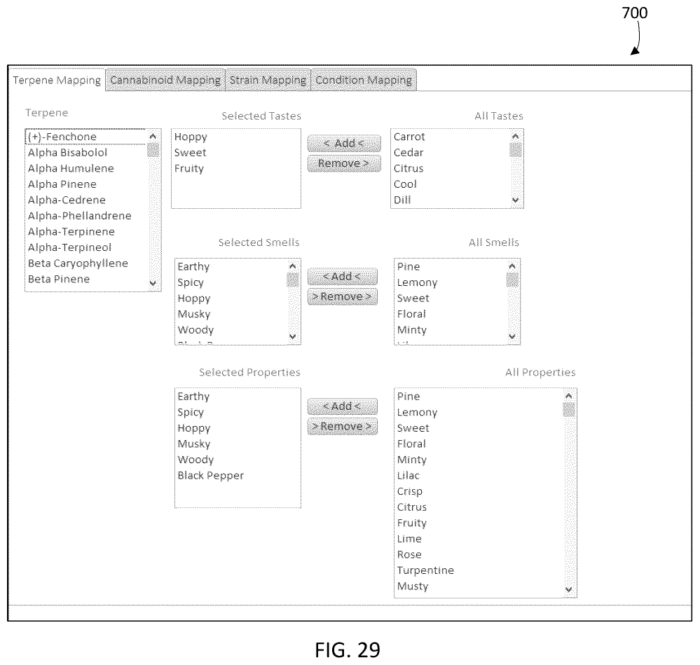

The overall score may be determined by a mapping schema 106, as shown in FIG. 1. The mapping schema 106 may develop and store associations that may form the basis to rank the Cannabis products according to the input received by the input-receiving-schema. The mapping schema may provide mapping in various ways. For example, as shown in FIGS. 29-31, an administrator interface may allow for custom mapping or standard mapping may be used. The various compounds (e.g., cannabinoids, flavonoids, and/or terpenes), either alone or in combination, may be associated, affiliated, or identified as having one or more biological effects such as therapeutic, medicinal, sensory, and/or other physiological responses.

For example, the biological effects may include but are not limited to anti-carcinogenic, anti-inflammatory, bronchodilator, appetite suppressant, pain reliever, anti-oxidant, stimulating, improving sleep quality, improving and/or mediating heart health, sedating, inhibition of tumors/fungus, repairing damaged bones, reducing or eliminating muscle spasms, antibacterial, anti-microbial, anti-convulsant, energizing, calming, anti-septic, easing congestion, uplifting, relieving anxiety, aiding sleep, anti-proliferative, osteoporosis prevention, helping with digestion, easing mild respiratory complaints, anti-viral, mood boosting, gastroprotective, inducing drowsiness, soothing irritated skin, improving concentration, and local anesthetic effects.

Each compound or the sum of a plurality of compounds may provide unique taste and smells. For example, the compounds, alone or in combination, may provide a bitter, citrus, cooling, earthy, fruity, grape, herbal, hoppy, lemon, lemon-lime, melon, mint, pepper, piney, sour, spice, sweet, woody taste and/or may provide an apple, citrus, dill, Eucalyptus, floral, forest, fruity, grassy, hoppy, lavender, lilac, lime, mint, musky, nutty, parsley, peach, pine, rose, rosemary, spicy, sweet, tropical, tropical sweet, and woody smell.

The biological effects may further be identified as main effects, secondary effects, and/or trace effects. For example, the compound methanol may have a main biological effect of alleviating pain, a secondary effect of acting as an anti-irritant, with a cool mint taste and smell. Similarly, for example, beta pinene may have a primary bronchodilator effect.

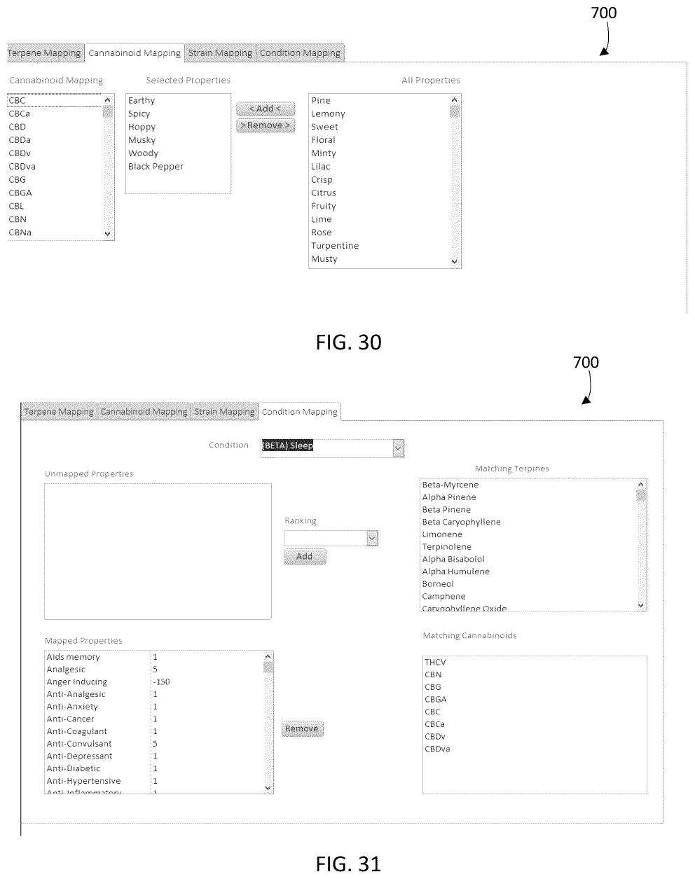

In various embodiments, the administrator interface for generating or creating mappings may allow an administrator to associate specific compounds with specific biological effects or attributes. For example, an administrator may associate one or more (e.g., each) terpenes (FIG. 29), cannabinoids (FIG. 30), and/or flavonoids with specific attributes, biological effects, taste, and/or smells. In a variation, the mapping may also include condition mapping to map specific biological effects, conditions, or the alleviation of symptoms to specific compounds, as shown in FIG. 31.

Associating compositional compounds with biological effects may be more accurate and reliable than many conventional practices that rely on employees' and/or consumers' reported experiences (i.e., feedback). For example, a consumer personal feedback may be used to modify a future recommendation or score for that consumer or other consumers. The Cannabis products including these compounds may likewise be associated with the biological effects. The quantity, amount, and/or concentration of the compounds may also be considered when associating the biological effects with a particular Cannabis product.

In a refinement, a scoring algorithm may be employed to determine a score for each available Cannabis product. For example, the Cannabis products may be scored with regards to how well they alleviate, treat, and/or prevent a condition such as chronic pain. The score may consider compounds that are present and their concentrations in a Cannabis product. For example, the score may weigh a Cannabis products effect for a specific condition based on the concentration of relevant compound(s) as provided in the compositional data received.

The biological effects may further be associated with particular conditions, as shown in FIG. 31. For example, each (known) compound (e.g., Beta-Myrcene, Alpha Pinene, Beta Pinene . . . THCV, CBN . . . ) may be mapped or associated with various properties (e.g., Aids memory, Analgesic, Anger Inducing . . . ) may be associated with a condition (e.g., “(Beta) Sleep”). The property may be associated with the condition based on a severity or associated with a weight (e.g., 1, 5, −150 . . . ). In this manner, the data structure identifies which compounds may be useful to prevent, treat, and/or alleviate conditions such as chronic or acute pain, cancer, inflammation, arthritis, anxiety, depression, insomnia, other sleep disorders, osteoporosis, HIV/AIDS, seizures, ALS, PTSD, Crohn's, glaucoma, fibromyalgia, migraines, Alzheimer's, heart disorders, autism, and/or a terminal illness. In this way, certain Cannabis products containing particular concentrations of particular compounds may be better or more appropriate in preventing, treating or alleviating particular conditions. In another refinement, particular combinations of Cannabis products may be suitable or more suitable for preventing, treating, or alleviating particular conditions. Thus, in a variation, the system and/or data structure may recommend combinations of Cannabis products.

Accordingly, each Cannabis product may be ranked for a particular condition based upon its compositional data via the scoring algorithm. The scoring algorithm may weigh the biological effects based on the concentrations of various or all compounds reported in the compositional data. For example, each compound may be scored to determine an overall score.

The algorithm may also be customized or personalized to the particular customer/consumer needs or based on the user inputs. For example, the customer/consumer input may be used to alter the scoring algorithm. A customer/consumer input may be used to assign a greater weight to desirable biological effects and lower weight to undesirable biological effects. For example, if a citrus taste is desirable, the score assigned to the Cannabis products based on the number and concentration of compounds suitable for treating a particular condition may be modified by a multiplier (e.g., 1.5 times greater). If an earthy taste is undesirable the score may likewise be modified by a fractional and/or negative multiplier (e.g., 0.5 multiplier) for Cannabis products with compounds providing an earthy taste. In other words, the attributes may be weighted based on the user inputs. In this way, the score is not particularly limited (e.g., −∞ to +∞) but based on the mapping schema and compositional data, and user input. Thus, the compositional data of the product may be accurately and objectively correlated with various properties and/or conditions to provide recommendations. For example, Table 1 below depicts a snapshot of seven compounds from compositional data of a product contributing to a score such as for a customer inputting that a desire to alleviate pain at night.

TABLE 1

| | Contribution | |
|---|---|---|
| Property/Biological Effect | to Score | Concentration |
| Bronchodilator | 1.4 | 0.100% |
| Increased meal foraging | −288.75 | 8.250% |
| Sedating | 866.25 | 8.250% |
| Analgesic | 28.875 | 8.250% |
| Anti-Convulsant | 2.94 | 0.840% |
| Energizing | −2.1 | 0.020% |
| Sedating | 2.1 | 0.020% |
| Sedating | 59.85 | 0.570% |
| Anti-Convulsant | 1.995 | 0.570% |
| Analgesic | 12.145 | 3.470% |
| Appetite Suppressant | 3.15 | 0.900% |

Table 1, for example, depicts a first compound with a concentration of 8.250% with three biological effects (e.g., Increased meal foraging, Sedating, Analgesic) contributing to the score based on the user input regarding preferences or conditions. As shown, the increased meal foraging effect of the compound contributes negatively to the score because the customer would like assistance sleeping where sedating effect positively contributes to the score.

In a refinement, certain compounds or compositional data may need to be ignored, excluded, and/or diluted. For example, strains having high concentrations of THC may overwhelm or dominate the scoring algorithm when considered on an equal basis. Thus, in some variations, THC may not be considered by the scoring algorithm. In other embodiments, the overwhelming THC concentrations may be mathematically diluted such as by applying a fractional multiplier. Further, customer/consumer inputs may dictate that the scoring algorithm exclude or require specific compounds. For example, an entry in user-interface 300 may allow a customer/consumer to include particular compounds or exclude particular compounds. For example, the minimum and/or maximum selection feature(s) 312 provides a customer/consumer the ability to require or exclude THC through the input-receiving schema 104 and modify/customize the scoring algorithm. The minimum and/or maximum selection feature(s) 312 likewise allows a customer/consumer the ability to set minimum and maximum thresholds for particular compounds.

Although described herein primarily with regards to compositional data and/or consumer conditions and preferences embodiments may likewise consider processing compounds and/or techniques as well as consumer information such as pre-existing disorders and/or hereditary disorders.

The computer executable instructions/code embodying the algorithms described herein are/is capable of being individually or collectively distributed as a program product in a variety of different form. The program code may be distributed using a computer readable storage medium having computer readable program instructions thereon for causing a processor to carry out aspects. Computer readable storage media, which is inherently non-transitory, may include volatile or non-volatile, and removable and non-removeable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device form of a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement functions, acts, and/or operations described herein. The functions, acts, and/or operations described herein may be re-ordered, processed serially, and/or processed concurrently.

For example, again referring to FIG. 2, the algorithms described herein are implemented using a computer platform 50. The computing platform 50 may include a processor 52, memory 54, and non-volatile storage 56. The processor 52 may include one or more devices selected from high-performance computing systems including high-performance cores, microprocessors, micro-controllers, digital signal processors, microcomputers, central processing units, field programmable gate arrays, programmable logic devices, state machines, logic circuits, analog circuits, digital circuits, or any other device that manipulate signals (analog or digital) based on computer-executable instructions residing in the memory 54. The memory 54 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 56 may include one or more persistent data storage devices such as a hard drive, optical drive, tape drive, non-volatile solid state device, cloud storage or any other device capable of persistently storing information.

The processor 52 may be configured to read into memory 54 and execute computer-executable instructions of the non-volatile storage 56 and embodying one or more of the algorithms described herein. Executable instruction may reside in a software module 58. The software module 58 may include operating systems and applications. The software module 58 may be compiled or interpreted from a computer program created using a variety of programming languages and/or technologies, including, without limitation, and either alone or in combination, Java, C, C++, C#, Objective C, Fortran, Pascal, Java Script, Python, Perl, and PL/SQL.

Upon execution by the processor 52, the computer-executable instruction of the software module 58 causes the computing platform 50 to implement one or more of the algorithms disclosed herein. Non-volatile storage 56 may also include data 60 supporting the functions, features, calculations, and processes. It should be further understood that numerous other devices may employ certain components as described herein and cooperate with other components.

In one or more embodiments, a method of searching for, identifying, and/or recommending one or more Cannabis products in real-time is disclosed. The method may include mapping associations between compounds, biological effects (i.e., step 1010), and/or conditions (i.e., step 1040), receiving compositional data of a plurality of Cannabis products (i.e., step 1020), identifying a plurality of compounds in the plurality of compounds (i.e., step 1030), associating those compounds with the products (i.e., step 1030), receiving consumer preference data such as biological conditions, taste, smells (i.e., step 1050), associating the compounds with one or more consumer preferences (i.e., step 1060), and providing a recommendation based on the compositional data, the consumer preference data, and/or the associations (i.e., step 1070). A mapping schema may be used to map the associations between compounds and biological effects as described above. An input-receiving schema, as described above may be used to receive the compositional data and consumer preference data. As described above, a scoring algorithm may be altered or modified to associate the plurality of compounds with the one or more consumer preferences and recommend one or more Cannabis products. For example, the systems and methods described herein may provide a real-time recommendation from at least 10 products, a hundred products, or a thousand products within, for example, a few minutes (e.g., 3, 5, 10 minutes), in less than 30 seconds, or even within 10 seconds.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A data structure embodied on a computer-readable medium having a database schema configured to acquire compositional data in a structured query language (SQL) database and providing a recommendation, the database schema comprising:
an input-receiving schema configured to receive compositional data of a Cannabis product and user data including user preference information and condition information; and
a mapping schema configured to assign a score to each of a plurality of Cannabis products based on the compositional data and user data, the mapping schema including a ranking schema representing relational data tables that associate portions of the compositional data with one or more conditions;
the input-receiving schema and mapping schema used by a selection processing application to display one or more Cannabis products from the plurality of Cannabis products with the greatest score(s) or scores above a threshold amount.

2. A system for identifying and selecting suitable Cannabis goods, the system comprising:
a non-transitory computer-readable medium having computer-executable instructions, the computer-executable instructions including:
a) associating one or more compounds with a biological effect;
b) associating the biological effect as a preventive and/or treatment to one or more biological conditions;
c) identifying a plurality of products and for each product:
i) receiving compositional data corresponding to the product;
ii) identifying a plurality of compounds corresponding to the product from the compositional data;
iii) assigning one or more biological effects to the product based on the associating step a);
d) receiving input associated with a consumer;
e) providing a recommendation based on the one or more biological effects assigned to each product and the input.

3. The system of claim 2, wherein the one or more compounds includes cannabinoids and terpenes.

4. The system of claim 3, wherein the one or more compounds includes compounds other than tetrahydrocannabinol.

5. The system of claim 3, wherein the recommendation is made by ranking each of the products with a score for each Cannabis product.

6. The system of claim 5, wherein ranking includes scoring each of the products based on amounts of each of the plurality of compounds identified from the compositional data.

7. The system of claim 6, wherein the recommendation includes at least three products according to ranking and displays a score for each.

8. The system of claim 2, wherein the input includes a consumer preference data.

9. The system of claim 8, wherein the consumer preference data includes a taste and/or smell.

10. The system of claim 8, wherein the consumer preference data includes an included or excluded cannabinoid or terpene.

11. The system of claim 10, wherein the consumer preference data includes a threshold amount of the included or excluded cannabinoid or terpene.

12. The system of claim 2, wherein the biological conditions include pain.

13. The system of claim 12, wherein the biological conditions include anxiety.

14. A method of selecting suitable Cannabis goods for a customer comprising:
receiving compositional data for a plurality of Cannabis products;
identifying a plurality of compounds of each Cannabis product;
associating the plurality of compounds with one or more conditions;
receiving consumer preference data;
associating the plurality of compounds with one or more user preferences; and
displaying a recommendation using a scoring algorithm that uses the compositional data, the consumer preference data, and associations to determine a score.

15. The method of claim 14, further comprising associating the plurality of compounds with one or more biological effects.

16. The method of claim 14, wherein the scoring algorithm weighs the impact of the plurality of compounds based on concentrations thereof to determine the score.

17. The method of claim 14, wherein the plurality of compounds includes one or more selected from the group consisting of cannabichromene (CBC), cannabidivarin (CBDV), cannabigerol (CBG), cannabicyclol (CBL), cannabinol (CBN), and/or tetrahydrocannabivarin (THCV), A-terpineol, alpha bisbolol, alpha cedrene, alpha pinene, alpha-humulene, alpha phellandrene, alpha terpinene, B/Y Terpineol, beta caryophyllene, beta pinene, beta mycrene, borneol, camphene, camphor, caryophyllene oxide, CBN, cedrol, cis-caryophyllene, cis-nerolidol, delta 3 came, endo-fenchyl alcohol, eucalyptol, famesene, frenchone, gamma-terpinene, geraniol, geranyl acetate, guaiol, hexahydrothymol (methanol), humulene, isoborneol, isopulegol, limonene, linalool, mycrene, nerol, nerolidol, ocimene, ocimene isomer 1, ocimene isomer 2, pulegone, sabinene, sabinene hydrate, terpineol, terpinolene, trans-caryophyllene, trans-nerolidol, terpineol, valencence, and y-terpinene.

18. The method of claim 17, wherein the plurality of compounds includes one or more of the group consisting of A-terpineol, alpha bisbolol, alpha cedrene, alpha pinene, alpha-humulene, alpha phellandrene, alpha terpinene, B/Y Terpineol, beta caryophyllene, beta pinene, beta mycrene, borneol, camphene, camphor, caryophyllene oxide, CBN, cedrol, cis-caryophyllene, cis-nerolidol, delta 3 came, endo-fenchyl alcohol, eucalyptol, famesene, frenchone, gamma-terpinene, geraniol, geranyl acetate, guaiol, hexahydrothymol (methanol), humulene, isoborneol, isopulegol, limonene, linalool, mycrene, nerol, nerolidol, ocimene, ocimene isomer 1, ocimene isomer 2, pulegone, sabinene, sabinene hydrate, terpineol, terpinolene, trans-caryophyllene, trans-nerolidol, terpineol, valencence, and y-terpinene.

19. The method of claim 14, wherein receiving the compositional data includes scanning a laboratory report and/or uploading laboratory results via an application programming interface.

20. The method of claim 14, wherein the one or more conditions include at least one selected from the group consisting of chronic or acute pain, cancer, inflammation, arthritis, anxiety, depression, insomnia, other sleep disorders, osteoporosis, HIV/AIDS, seizures, ALS, PTSD, Crohn's, glaucoma, fibromyalgia, migraines, Alzheimer's, heart disorders, autism, and a terminal illness.
